(19) United States
(12) Patent Application Publication
(10) Pub. No.: US 2023/0249603 A1
(43) Pub. Date: Aug. 10, 2023

(54) Locking Ratchet Strap Device

(71) Applicant: Aaron Stiles, Waynesburg, PA (US)

(72) Inventor: Aaron Stiles, Waynesburg, PA (US)

(21) Appl. No.: 18/164,574

(22) Filed: Feb. 4, 2023

Related U.S. Application Data
(60) Provisional application No. 63/306,688, filed on Feb. 4, 2022.

(51) Int. Cl. B60P 7/08

(52) U.S. Cl. CPC B60P 7/083

(57) ABSTRACT

The present invention relates to a locking ratchet strap that prevents theft and unintentional cargo loss. The device has a first strap and a second strap that attach to a ratchet mechanism which allows the straps to tighten. Each strap is made from a cut-resistant material. A release catch of the ratcheting mechanism is comprised of a lock that prevents the mechanism from becoming loose or operated by an unauthorized user (i.e., a thief). Each strap may be comprised of a hook having a lock member that can be manipulated from within each hook to form each hook into a continuous loop. The lock member can then be locked into this position via a lock. This prevents the hooks from becoming unsecured from an anchor point during transport.

### CROSS-REFERENCE TO RELATED APPLICATION

The present application claims priority to, and the benefit of, U.S. Provisional Application No. 63/306,688, which was filed on Feb. 4, 2022, and is incorporated herein by reference in its entirety.

### FIELD OF THE INVENTION

The present invention relates generally to the field of ratchet straps. More specifically, the present invention relates to a locking ratchet strap. The device has a first strap and a second strap that attach to a ratchet mechanism, which allows the straps to tighten. Each strap is made from a cut-resistant material. A release catch of the ratcheting mechanism is comprised of a lock that prevents the mechanism from becoming loose or operated by an unauthorized user (i.e., a thief). Each strap may be comprised of a hook having a lock member that can be manipulated from within each hook to form each hook into a continuous loop. The lock member can then be locked into this position via a lock to prevent the hooks from becoming unsecure from an anchor point during transport. Accordingly, the present disclosure makes specific reference thereto. Nonetheless, it is to be appreciated that aspects of the present invention are also equally applicable to other like applications, devices, and methods of manufacture.

### BACKGROUND

Cargo stored on/in pickup trucks, garages, vans, and various other locations may be tied down with a ratchet strap system. These straps are typically constructed using nylon which can be easily cut. This allows the strap system to be removed from around the cargo which allows the cargo to be stolen.

In addition, ratchet straps of ratchet strap systems are typically comprised of a hook that can be secured to an anchor point. If the system malfunctions during transport, the straps can become loose and cause the hook to become unsecured from the anchor point. This can lead to cargo falling/moving and becoming damaged or lost.

Therefore, there exists a long-felt need in the art for an improved ratchet strap system. There also exists a long-felt need in the art for a locking ratchet strap device that cannot be easily cut during an attempted theft. In addition, there exists a long-felt need in the art for a locking ratchet strap device that cannot become loose during transport. Further, there exists a long-felt need in the art for a locking ratchet strap device that eliminates the possibility of a ratchet strap hook from becoming unsecured from an anchor point.

The subject matter disclosed and claimed herein, in one embodiment thereof, comprises a locking ratchet strap device. The device is primarily comprised of a ratchet mechanism with a release catch having at least one lock, a first strap, a second strap, and at least one hook having at least one lock. The first strap and the second strap attach to the ratchet mechanism which allows the straps to tighten. Each strap is made from a cut-resistant material. The release catch of the ratcheting mechanism is comprised of a lock that prevents the mechanism from becoming loose or operated by an unauthorized user (i.e., a thief). Each strap may be comprised of a hook. Each hooking is comprised of a lock member that can be manipulated from within each hook to form each hook into a continuous loop. The lock member can then be locked into this position via a lock. This prevents the hooks from becoming unsecure from an anchor point during transport.

In this manner, the locking ratchet strap device of the present invention accomplishes all the foregoing objectives and provides an improved ratchet strap system. To do so, the device provides a ratchet strap device that cannot be easily cut during an attempted theft and that cannot become loose during transport. Further, the device that eliminates the possibility of a ratchet strap hook from becoming unsecured from an anchor point.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a locking ratchet strap device. The device is primarily comprised of a ratchet mechanism with a release catch having at least one lock, a first strap, a second strap, and at least one hook having at least one lock. The mechanism is comprised of at least one handle that can be grabbed by a user to allow a user to crank the ratchet mechanism to tighten or loosen the straps of the device. The ratchet mechanism also has at least one windlass. The windlass is comprised of at least one opening that allows the first end of the first strap to be placed into the windlass.

The mechanism is also comprised of a first pawl and a second pawl. The pawls are positioned on each side of the windlass. The first pawl is located near the handle and allows the ratchet mechanism to loosen via the release catch. The second pawl serves as an anchoring point for the second strap. The release catch of the first pawl can be pulled upward to loosen the ratchet mechanism and release tension in the straps. The release catch is comprised of at least one lock that when in the locked position, prevents the release catch from being moved (to loosen the device) by extending a lock member into at least one opening in the frame of the ratchet mechanism. This prevents the device from being removed from the object it is retaining and thereby prevents the object and the device from being stolen. The lock may be protected by at least one cover.

The second end of the first strap is comprised of at least one hook that allows the strap to be secured to an anchor point of a trailer, truck, etc. The hook is preferably a J-shaped hook having at least one lock member. The lock member can be manipulated via at least one button or slide such that the member makes the hook continuous. The lock member can then be secured in this locked position by at least one lock positioned on the hook. The lock may be protected by at least one cover. The same hook structure may be also found on the second strap.

The first strap and the second strap are preferably comprised of a cut-resistant material that prevents the straps from being cut when there is an attempted theft of the object the device is securing. The strap material is preferably comprised of a combination of nylon and stainless steel. The stainless steel is preferably braided with the nylon material.

Accordingly, the locking ratchet strap device of the present invention is particularly advantageous as it provides an improved ratchet strap system that cannot be easily cut during an attempted theft and that cannot become loose during transport. Further, the device eliminates the possibility of a ratchet strap hook from becoming unsecured from an anchor point. In this manner, the locking ratchet strap device overcomes the limitations of existing ratchet strap systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a locking ratchet strap device of the present invention in accordance with the disclosed architecture;

FIG. 2 illustrates an enhanced view of a ratchet mechanism of one potential embodiment of a locking ratchet strap device of the present invention in accordance with the disclosed architecture;

FIG. 3 illustrates a perspective view of one potential embodiment of a locking ratchet strap device of the present invention while being used to secure cargo in accordance with the disclosed architecture; and

FIG. 4 illustrates a flow chart of a method of using one potential embodiment of a locking ratchet strap device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved ratchet strap system. There also exists a long-felt need in the art for a locking ratchet strap device that cannot be easily cut during an attempted theft. In addition, there exists a long-felt need in the art for a locking ratchet strap device that cannot become loose during transport. Further, there exists a long-felt need in the art for a locking ratchet strap device that eliminates the possibility of a ratchet strap hook from becoming unsecured from an anchor point.

The present invention, in one exemplary embodiment, is comprised of a locking ratchet strap device primarily comprised of a ratchet mechanism with a release catch having at least one lock, a first strap, a second strap, and at least one hook having at least one lock. The mechanism is comprised of at least one handle that can be grabbed by a user to allow a user to crank the ratchet mechanism to tighten or loosen the straps of the device. The ratchet mechanism also has at least one windlass having at least one opening that allows the first end of the first strap to be placed into the windlass.

The mechanism is also comprised of a first pawl and a second pawl which are positioned on each side of the windlass. The first pawl is located near the handle and allows the ratchet mechanism to loosen via the release catch. The second pawl serves as an anchoring point for the second strap. The release catch of the first pawl can be pulled upward to loosen the ratchet mechanism and release tension in the straps.

The release catch is comprised of at least one lock that when in the locked position, prevents the release catch from being moved (to loosen the device) by extending a lock member into at least one opening in the frame of the ratchet mechanism. This prevents the device from being removed from the object it is retaining and thereby prevents the object and the device from being stolen. The lock may be protected by at least one cover.

The second end of the first strap is comprised of at least one hook that allows the strap to be secured to an anchor point of a trailer, truck, etc. The hook is preferably a J-shaped hook having at least one lock member that can be manipulated via at least one button or slide such that the member makes the hook continuous. The lock member can then be secured in this locked position by at least one lock positioned on the hook. The lock may be protected by at least one cover. The same hook structure may be also found on the second strap.

The first strap and the second strap are preferably comprised of a cut-resistant material. This prevents the straps from being cut when there is an attempted theft of the object the device is securing. The strap material is preferably comprised of a combination of nylon and stainless steel. The stainless steel is preferably braided with the nylon material.

Accordingly, the locking ratchet strap device of the present invention is particularly advantageous as it provides an improved ratchet strap system that cannot be easily cut during an attempted theft and that cannot become loose during transport. Further, the device eliminates the possibility of a ratchet strap hook from becoming unsecured from an anchor point. In this manner, the locking ratchet strap device overcomes the limitations of existing ratchet strap systems known in the art.

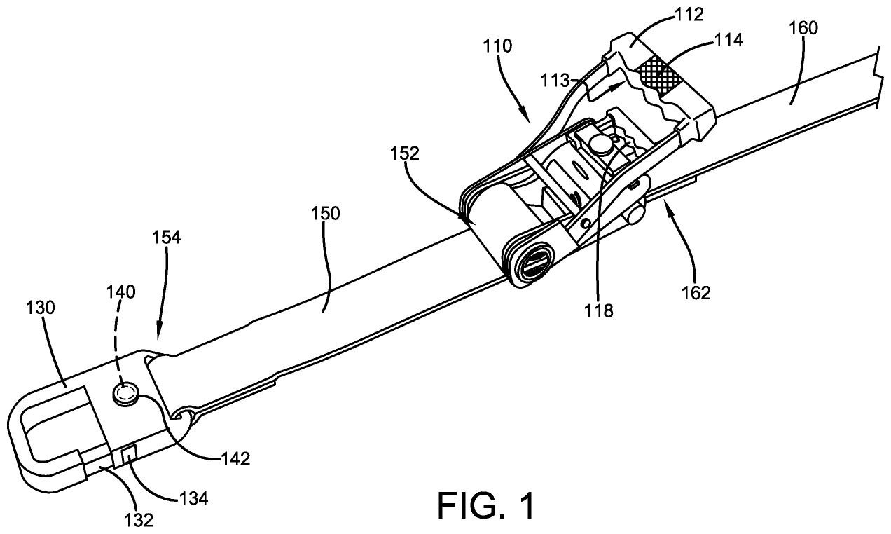

Referring initially to the drawings, FIG. 1 illustrates a perspective view of one potential embodiment of a locking ratchet strap device 100 of the present invention in accordance with the disclosed architecture. The device 100 is primarily comprised of a ratchet mechanism 110 with a release catch 120 having at least one lock 122, a first strap 150, a second strap 160, and at least one hook 130 having at least one lock 140. The ratchet mechanism 110 is preferably made from a rigid metal such as, but not limited to, stainless steel or aluminum. The material of the mechanism 110 is preferably corrosion-resistant to protect against rust.

The mechanism 110 is comprised of at least one handle 112. The handle 112 can be grabbed by a user to allow a user to crank the ratchet mechanism 110 to tighten or loosen the straps 150,160 of the device.

The handle 112 may be any shape known in the art. In one embodiment, the handle 112 is ergonomically shaped with a plurality of finger grooves 113. In another embodiment, the handle 112 may be comprised of at least one grip area 114. The grip area 114 may be textured with a recessed or raised texture or may be non-textured. The grip area 114 is preferably made from a non-slip material that improves grip such as but not limited to silicone, latex, neoprene, EPDM, PVC foam, polyethylene, sponge rubber, silicone foam, urethane, cork, ridged and/or recessed rubber, felt, acrylic, polyester & SBR, etc.

The mechanism 110 is comprised of at least one windlass 115. The windlass 115 is comprised of at least one opening 116. The opening 116 allows the first end 152 of the first strap 150 to be placed into the windlass 115.

The device 100 is also comprised of a first pawl 118 and a second pawl 119. The pawls 118, 119 are positioned on each side of the windlass 115. The first pawl 118 is located near the handle 112 and allows the ratchet mechanism 110 to loosen via the release catch 120. The second pawl 119 serves as an anchoring point for the second strap 160.

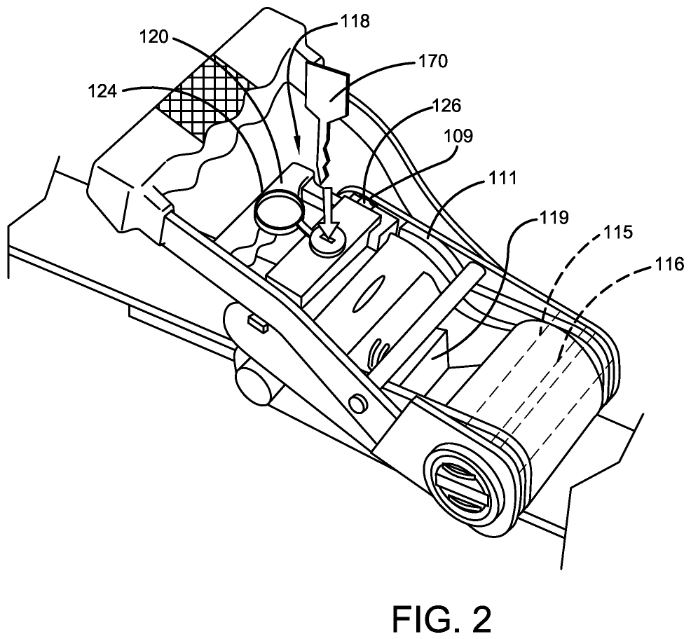

FIG. 2 illustrates an enhanced view of a ratchet mechanism 110 of one potential embodiment of a locking ratchet strap device 100 of the present invention in accordance with the disclosed architecture. At least one release catch 120 on the first pawl 118 can be pulled upward to loosen the ratchet mechanism 110 and release tension in the straps 150,160. The release catch 120 is comprised of at least one lock 122. When in the locked position, the lock 122 prevents the release catch 120 from being moved (to loosen the device 100) by extending a lock member 126 into at least one opening 109 in the frame 111 of the ratchet mechanism 110. This prevents the device 100 from being removed from the object 20 it is retaining and thereby prevents the object and the device 100 from being stolen.

The lock 122 may be any lock type known in the art. This includes, but is not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, etc. In the preferred embodiment, the lock 122 is a key lock that can be locked and unlocked by at least one key 170.

The lock 122 may be protected by at least one cover 124. The cover 124 protects the lock 122 from being filled with dust and debris during use. In one embodiment, the cover 124 preferably seals the lock 122 such that the lock 122 is waterproof.

The second end 154 of the first strap 150 is comprised of at least one hook 130. The hook 130 allows the strap 150 to be secured to an anchor point 10 of a trailer, truck, etc. The hook 130 is preferably a J-shaped hook, but may be any shape known in the art. The hook 130 is preferably comprised of a lock member 132. The lock member 132 can be manipulated via at least one button 134 or slide such that the member 132 makes the hook 130 continuous. In one embodiment, the lock member 132 can be moved to make the hook 130 continuous by locking and unlocking the lock 140. The lock member 132 can then be secured in this locked position by at least one lock 140 positioned on the hook 130.

The lock 140 may be any lock type known in the art. This includes, but is not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, etc. In the preferred embodiment, the lock 140 is a key lock that can be locked and unlocked by at least one key 170.

The lock 140 may be protected by at least one cover 142. The cover 142 protects the lock 140 from being filled with dust and debris during use. In one embodiment, the cover 142 preferably seals the lock 140 such that the lock is waterproof.

The first end 162 of the second strap 160 attaches to the ratchet mechanism 110. The second end 164 of the strap 160 may be comprised of at least one hook 130. The hook 130 allows the strap 160 to be secured to an anchor point 10 of a trailer, truck, etc. The hook 130 is preferably a J-shaped hook, but may be any shape known in the art. The hook 130 is preferably comprised of a lock member 132. The lock member 132 can be manipulated via at least one button 134 or slide such that the member 132 makes the hook 130 continuous. In one embodiment, the lock member 132 can be moved to make the hook 130 continuous by locking and unlocking the lock 140. The lock member 132 can then be secured in this locked position by at least one lock 140 positioned on the hook 130. This prevents the hook 130 from coming unhooked during transport and/or being removed by a thief.

The lock 140 may be any lock type known in the art. This includes, but is not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, etc. In the preferred embodiment, the lock 140 is a key lock that can be locked and unlocked by at least one key 170.

The first strap 150 and the second strap 160 are preferably comprised of a cut-resistant material. This prevents the straps 150,160 from being cut when there is an attempted of the object 20 the device 100 is securing. The strap 150,160 material is preferably comprised of a combination of nylon and stainless steel. The stainless steel is preferably braided with the nylon material.

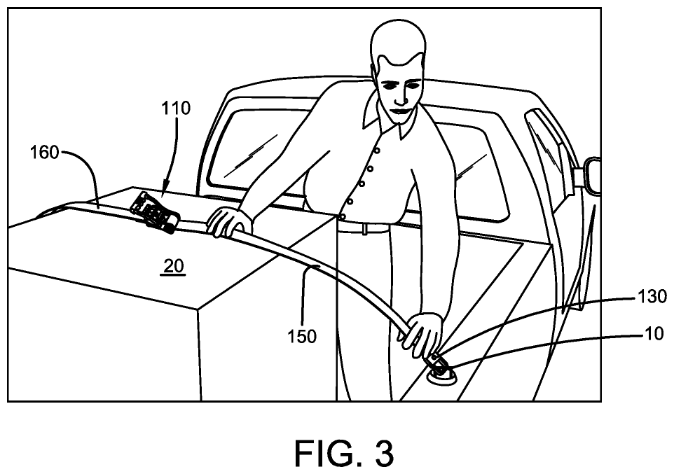

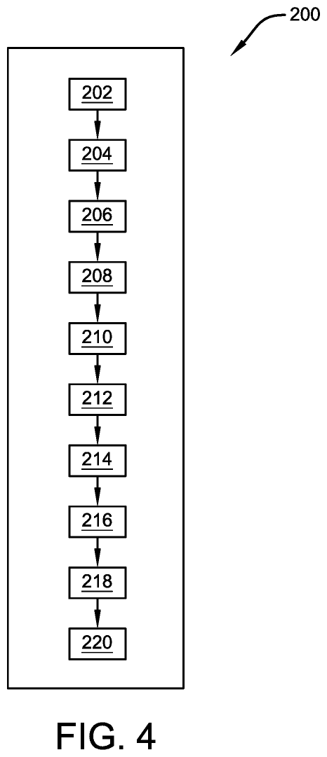

FIG. 4 illustrates a flow chart of a method of using 200 one potential embodiment of a locking ratchet strap device 100 of the present invention in accordance with the disclosed architecture. The device 100 is also comprised of a method of use 200. First, the release catch 120 can be pulled toward (i.e., toward the handle 112) to disengage the ratchet mechanism 110 [Step 202]. Then, the first end 152 of the first strap 150 is fed through the opening 116 of the windlass 115 [Step 204]. Next, the hook 130 of each strap 150,160 is attached to an anchor point 10 on a travel, pickup truck bed, etc., over a piece of cargo 20, as seen in FIG. 3 [Step 206]. Next, the lock member 140 of each hook 130 is pushed upward from within the hook 130 (using the button 134, or in another embodiment by locking the lock 140) such that the hook 130 becomes continuous [Step 208]. The hooks 130 can then be locked in this position using the lock 140 and the key 170, as can the lock 122 on the release catch 120 [Step 210]. Then, the ratchet mechanism 110 can be tightened by repeatedly cranking the ratchet handle 112 [Step 212]. When a user is ready to remove the device 100, the release catch 120 can be pulled upward (i.e., toward the handle 112) such that the ratchet mechanism 110 is released [Step 214]. Then, the lock 122 of the release catch 120 and the lock 140 of each hook 130 can be unlocked using the key 170 [Step 216]. The lock member 132 of each hook 130 can then be pressed downward into the hook 130 body such that the hook 130 is no longer continuous around the anchor point 10 [Step 218]. This allows each hook 130 to be removed from each anchor point 10 [Step 220].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “locking ratchet strap device” and “device” are interchangeable and refer to the locking ratchet strap device 100 of the present invention.

Notwithstanding the foregoing, the locking ratchet strap device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the locking ratchet strap device 100 as shown in the FIGS. are for illustrative purposes only, and that many other sizes and shapes of the locking ratchet strap device 100 are well within the scope of the present disclosure. Although the dimensions of the locking ratchet strap device 100 are important design parameters for user convenience, the locking ratchet strap device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locking ratchet strap device comprising:
a ratchet mechanism;
a handle;
a windlass comprised of an opening;
a first pawl;
a release catch having a first lock;
a second pawl;
a first strap comprised of a hook having a second lock, and
a second strap.

2. The locking ratchet strap device of claim 1, wherein each of the first strap and the second strap is comprised of a cut-resistant material.

3. The locking ratchet strap device of claim 2, wherein the cut-resistant material is comprised of a combination of a nylon and a braided steel material.

4. The locking ratchet strap device of claim 1, wherein the windlass is positioned between the first pawl and the second pawl.

5. A locking ratchet strap device comprising:
a ratchet mechanism;
a handle;
a windlass having an opening;
a first pawl;
a release catch comprised of a first lock, wherein the release catch is attached to the first pawl;
a second pawl;
a first strap comprised of a hook having a second lock; and
a second strap.

6. The locking ratchet strap device of claim 5, wherein a lock member of the hook can be manipulated by a button, a slide, or by the second lock.

7. A locking ratchet strap device comprising:
a ratchet mechanism;
a handle;
a windlass having an opening;
a first pawl;
a release catch comprised of a first lock and a first cover;
a second pawl;
a first strap comprised of a first hook having a second lock and a second cover; and
a second strap comprised of a second hook having a third lock and a third cover.

8. The locking ratchet strap device of claim 7, wherein the handle is comprised of a finger groove.

9. The locking ratchet strap device of claim 7, wherein the handle is comprised of a grip area.

10. The locking ratchet strap device of claim 7, wherein the second strap attaches to the second pawl.

11. The locking ratchet strap device of claim 7, wherein each of the first cover, the second cover and the third cover is comprised of a dust cover.

12. The locking ratchet strap device of claim 7, wherein each of the first cover, the second cover and the third cover is comprised of a waterproof cover.

13. The locking ratchet strap device of claim 7, wherein the first lock, the second lock, and the third lock are each comprised of a key lock, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, or a fixed core lock.

14. The locking ratchet strap device of claim 7 further comprised of a key.

15. The locking ratchet strap device of claim 7, wherein the first hook is comprised of a first locking member.

16. The locking ratchet strap device of claim 15, wherein the first locking member can be moved by turning the second lock.

17. The locking ratchet strap device of claim 7, wherein the first hook is comprised of a second locking member.

18. The locking ratchet strap device of claim 17, wherein the first locking member can be moved by turning the third lock.

19. The locking ratchet strap device of claim 7, wherein a frame of the ratchet mechanism is comprised of an opening.

20. The locking ratchet strap device of claim 7, wherein the release catch is comprised of a lock member.
